(19) United States
(12) Patent Application Publication
(10) Pub. No.: US 2009/0248729 A1
(43) Pub. Date: Oct. 1, 2009

(54) ONLINE APPLICATION PLATFORM AND USER COMMUNITIES

(75) Inventors: John P. Bruno, JR., Snoqualmie, WA (US); Jacob D. Kim, Issaquah, WA (US); Thomas A. Jeyaseelan, Kirkland, WA (US); Charles D. Bassett, Seattle, WA (US); Benjamin C. Walters, Seattle, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/055,286

(22) Filed: Mar. 25, 2008

(51) Int. Cl. G06F 17/30; G06F 3/00

(52) U.S. Cl. 707/102; 715/733; 707/E17.001

(57) ABSTRACT

A method and a system provide an online application platform in which an entity may create applications to be shared among users of a user community. The online application platform may provide the users of the user community with information regarding applications and entities and may provide the users with an interface for providing feedback with respect to the applications and the entities. The online application platform may track usage of the applications and may store data with respect to the tracked usage. The data may be used to generate business intelligence, which may be used to improve the applications, market the applications, or for other useful purposes. The users of the user community may subscribe to an information update service to receive dynamically communicated application updates, or other information.

### BACKGROUND

Existing online application platforms permit a software developer to develop applications in a context of an existing system. However, the existing online application platforms have a number of shortcomings. For example, the online application platforms do not collect and provide data with respect to how an application is used, where the application is used, popularity of the application, and user feedback. Further, the online application platforms may permit the developed applications to execute in the context of the existing system, but no facility is provided to permit the developed applications to execute outside of the context of the existing system.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

In embodiments consistent with the subject matter of this disclosure, a method and a system may be provided, such that an entity may create applications to be shared among users of a user community. The system may provision resources for the entity and the application and may establish an interface for users to provide feedback regarding the application and/or the entity.

Embodiments of the system may track and store data regarding usage of applications, such that the data may be processed to produce business intelligence for improving the applications, for marketing the applications, or for other useful purposes.

Users may become subscribers to an information update service to receive information regarding application updates, patches or workarounds, which may be dynamically communicated via a RSS feed, e-mail, instant messaging, or other means.

### DRAWINGS

In order to describe the manner in which the above-recited and other advantages and features can be obtained, a more particular description is described below and will be rendered by reference to specific embodiments thereof which are illustrated in the appended drawings. Understanding that these drawings depict only typical embodiments and are not therefore to be considered to be limiting of its scope, implementations will be described and explained with additional specificity and detail through the use of the accompanying drawings.

FIG. 1 illustrates an exemplary functional block diagram of a system consistent with the subject matter of this disclosure.

FIG. 2 illustrates a functional block diagram of a processing device, which may implement one or more components of a system consistent with the subject matter of this disclosure.

FIG. 3 is an exemplary flow diagram, which explains data flow and processing in an embodiment consistent with the subject matter of this disclosure.

FIG. 4 is a flowchart illustrating an exemplary process for provisioning an entity and an application in an embodiment consistent with the subject matter of this disclosure.

FIG. 5 is a flowchart illustrating an exemplary process for provisioning a second party in embodiments consistent with the subject matter of this disclosure.

FIG. 6 is a flowchart illustrating an exemplary process for processing a command to share an application in embodiments consistent with the subject matter of this disclosure.

### DETAILED DESCRIPTION

Embodiments are discussed in detail below. While specific implementations are discussed, it is to be understood that this is done for illustration purposes only. A person skilled in the relevant art will recognize that other components and configurations may be used without parting from the spirit and scope of the subject matter of this disclosure.

### Overview

Embodiments consistent with the subject matter of this disclosure may provide a method and a system for a third party, such as a software developer, or other entity, to develop applications, which may be shared among a user community and which may use system application program interfaces (APIs) or other APIs. The system may provide an interface for a community of users to view information about an application or an entity and to provide feedback, reviews, ratings, as well as other information, with respect to the entity and the application.

In some embodiments, the system may track usage of applications and may provide business intelligence to entities, based on the tracked usage. The tracked information may include, for example, who uses an application, successful or unsuccessful use of the application, whether problems occur regarding execution of the application, types of problems that occur during execution of the application, how long the application is used, where the application is popular, as well as other useful information which may be used to provide business intelligence.

Embodiments of the system may permit users to subscribe to receive information regarding particular applications. For example, users may electronically receive information regarding application updates, patches or workarounds to address known application problems, information about new versions, as well as other useful information.

### Exemplary System

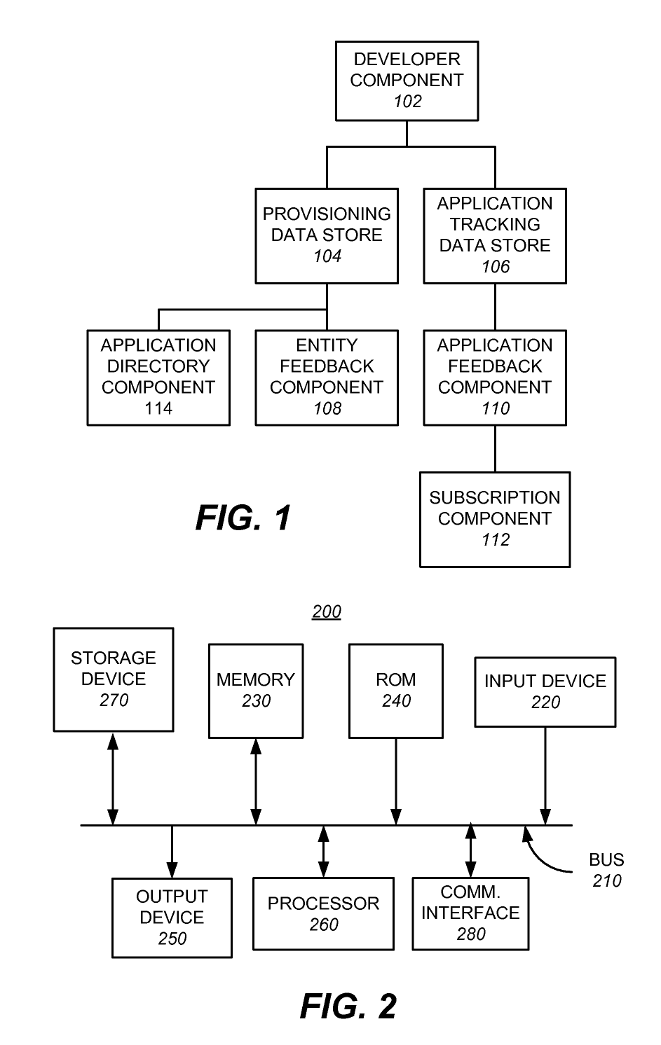

FIG. 1 illustrates a functional block diagram of an exemplary system for providing online application tools and user communities. The system may include a developer component 102, a provisioning data store 104, an application tracking data store 106, an entity feedback component 108, an application feedback component 110, a subscription component 112, and an application directory component 114.

Developer component 102 may permit developers or entities to remotely access the system via a wired, or wireless network, or a combination of networks, which may include, for example, the Internet, or other networks. Developer component 102 may permit a user to create a new application and to provide information regarding the application, such as, for example, application metadata, or other information.

Provisioning data store 104 may store information with respect to the entity, the application, resources assigned to the entity and the application, as well as other information. In some embodiments, provisioning data store 104 may store application provisioning records including application information, such as, for example, application metadata.

Application tracking data store 106 may store tracked information with respect to execution of applications. The tracked information may include information with respect to successful or unsuccessful use of the application, whether problems occur regarding execution of the application, types of problems that occur during execution of the application, how long the application is used, where the application is popular, based execution of the application, performance characteristics of the application, frequency of application program interface (API) usage by the application, as well as other useful information which may be used to provide business intelligence.

Entity feedback component 108 may provide a facility for users to remotely provide feedback regarding an entity. Application feedback component 110 may provide a facility for users to remotely provide feedback regarding an application. Provided feedback may include reviews and ratings, as well as other useful information. In some embodiments, entity feedback component 108 may be a webpage for providing information to users about an entity and for users to provide feedback for the entity. Application feedback component 110 may be a webpage for providing information to users about an application and for users to provide feedback regarding the application. In other embodiments, entity feedback component 108 and application feedback component 110 may implement an interface for users to provide feedback in another manner.

Subscription component 112 may be a facility for providing users a way to subscribe to receive information regarding applications. The information may be electronically provided and may include, for example, information regarding application updates, patches or workarounds to address known application problems, information about new versions, as well as other useful information. In an embodiment in which application feedback component 110 is implemented as a webpage, users may subscribe to an information update service, via the webpage, to receive application information. For example, users may subscribe by entering user information via a portion of the webpage. In other embodiments, users may subscribe via other methods. The application information may be dynamically communicated electronically to users via a number of methods, including but not limited to, a Really Simple Syndication (RSS) feed, an Atom feed, e-mail, instant messages, as well as a number of other methods.

Application directory component 114 may create and store a searchable application directory based, at least in part, on provided application metadata. Further, application directory component 114 may tag entries of the searchable application directory based, at least in part, on the provide application metadata. For example, application metadata may indicate that an application is an application for editing and managing collections of digital photos. In this example, application directory component 114 may tag an entry of the application directory, corresponding to the application for editing and managing collections of digital photos, as being related to photography.

Each of developer component 102, provisioning data store 104, application tracking data store 106, entity feedback component 108, application feedback component 110, subscription component 112, and application directory component 114 may be implemented in a separate processing device, in a single processing device, or some components may be combined in a single processing device while other components may be implemented in separate processing devices. In embodiments including multiple processing devices, the multiple processing devices may communicate with one another via a wired or wireless network, or a combination of networks.

### Exemplary Processing Device

FIG. 2 is a functional block diagram of an exemplary processing device 200, which may be used to implement any or all of developer component 102, provisioning data store 104, application tracking data store 106, entity feedback component 108, application feedback component 110, subscription component 112, and application directory component 114 in embodiments consistent with the subject matter of this disclosure. Processing device 200 may be a desktop personal computer (PC), a laptop PC, a handheld processing device, a server, or other processing device. Processing device 200 may include a bus 210, an input device 220, a memory 230, a read only memory (ROM) 240, an output device 250, a processor 260, a storage device 270, and a communication interface 280. Bus 210 may permit communication among components of processing device 200.

Processor 260 may include at least one conventional processor or microprocessor that interprets and executes instructions. Memory 230 may be a random access memory (RAM) or another type of dynamic storage device that stores information and instructions for execution by processor 260. Memory 230 may also store temporary variables or other intermediate information used during execution of instructions by processor 260. ROM 240 may include a conventional ROM device or another type of static storage device that stores static information and instructions for processor 260. Storage device 270 may include compact disc (CD), digital video disc (DVD), a magnetic medium, or other type of storage device for storing data and/or instructions for processor 260.

Input device 220 may include a keyboard or other input device. Output device 250 may include one or more conventional mechanisms that output information, including one or more display monitors, or other output devices. Communication interface 280 may include a transceiver for communicating over one or more networks via a wired, wireless, fiber optic, or other connection.

Processing device 200 may perform such functions in response to processor 260 executing sequences of instructions contained in a tangible machine-readable medium, such as, for example, memory 230, ROM 240, storage device 270 or other medium. Such instructions may be read into memory 230 from another machine-readable medium or from a separate device via communication interface 280.

### Exemplary Flow Diagram

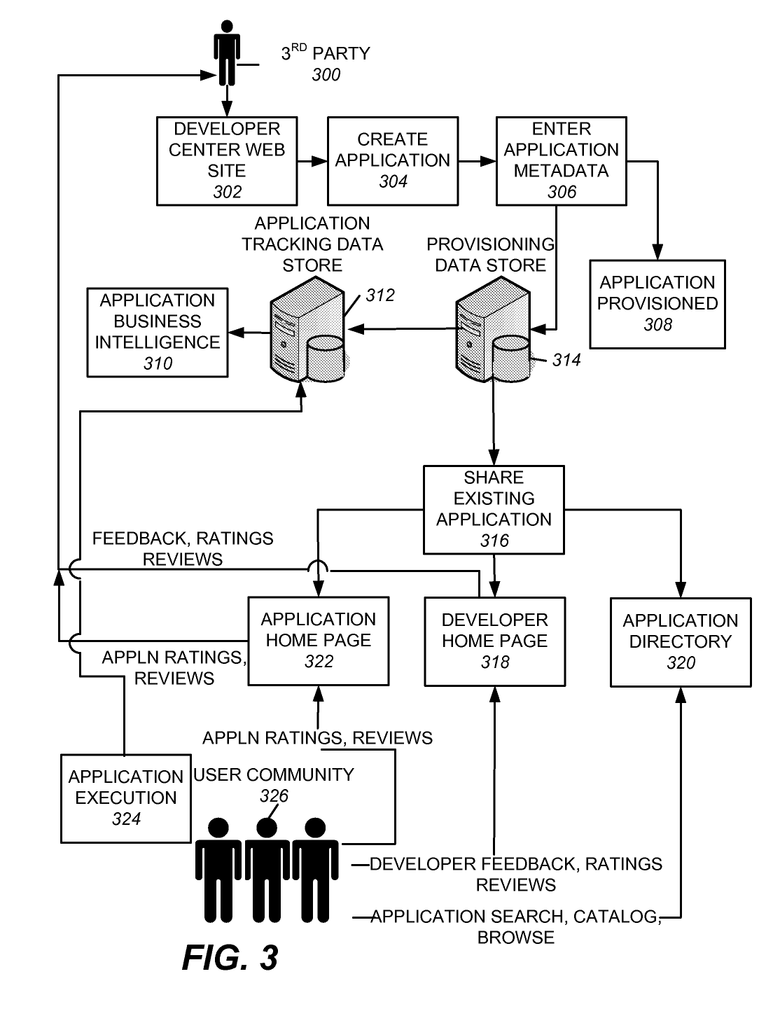

FIG. 3 is a flow diagram which illustrates exemplary processing and data flow in an embodiment of a system consistent with the subject matter of this disclosure. According to FIG. 3, a third party 300, such as, for example, a developer or other entity, may remotely access a developer center web site 302 via a network (not shown). Third party 300 may use a processing device to connect to developer center web site 302 via the network.

While accessing developer center web site 302, third party 300 may create an application 304. Third-party 300 may create the application by uploading the application from another processing device, by providing a link to an external resource which may include a copy of the application, or by a number of other methods. Third party 300 may then enter application metadata 306 describing the application. For example, third party 300 may provide textual data describing the application. The system may then provision the application 308 by, for example, creating an application provisioning record, which may include information about the entity, when the application was created, the name of the application, whether any localized resources are used for the application, a location from which an application request may come, as well as different or other information.

Provisioning data store 314 may store data related to provisioning, such as, for example, application provisioning records, application metadata, entity information, as well as other information.

Application tracking data store 312 may store information related to tracking execution of applications 324. The information may be derived from data in provisional data store 314, or from other sources. Application business intelligence 310 may be generated based on the stored information related to tracking of execution of applications 324.

In some embodiments, upon receiving a command to share an existing application 316, a developer home page 318 and an application home page 322 may be established. Developer home page 318 may include an interface for receiving developer feedback, ratings, reviews, and/or other information related to the entity from users of user community 326. Application home page 322 may include an interface for receiving application ratings, reviews, and/or other information related to an application from the users of user community 326. Third party 300 may receive information provided by user community 326 via developer home page 318 and application home page 322 by accessing home pages 318, 322, by automatically providing feedback to a third party 300 via e-mail, instant messaging, or other methods.

Upon receiving a command to share existing application 316, a corresponding entry of application directory 320, which may have previously been accessible only to certain parties, such as, for example, parties affiliated with third party 300, may be made accessible, or discoverable, to other users of user community 326. Thus, users of user community 326 may search, or browse application directory 320, which may include entries tagged or cataloged based, at least in part, on provided application metadata.

### Exemplary Processes

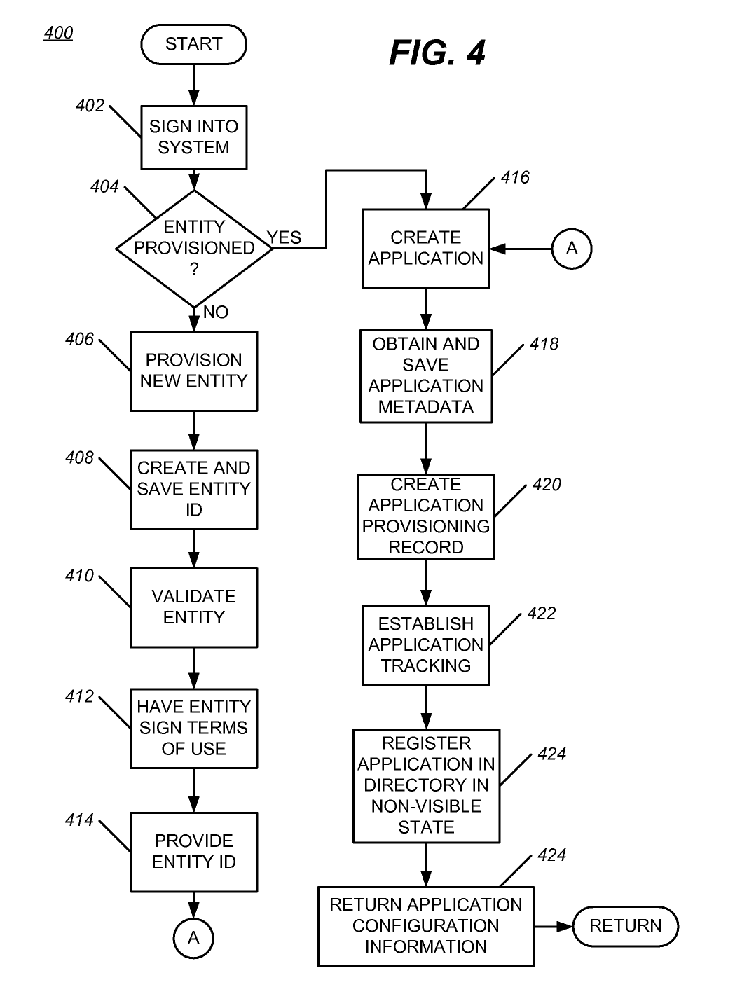

FIG. 4 illustrates a flowchart of an exemplary process for provisioning an entity and an application in embodiments consistent with the subject matter of this disclosure. The process may begin with an entity, such as, for example, a developer or third party, or other entity, signing into a system (act 402). The entity may sign in remotely by using a processing device of the entity and a network to access developer component 102. Developer component 102 may determine whether the entity is already provisioned (act 404).

If developer component 102 determines that the entity is not already provisioned, then developer component 102 may provision the entity (act 406). Developer component 102 may provision the entity by allocating resources for the entity, such as, for example, space in provisional data store 314 and application tracking data store 312, or by performing another action. Developer component 102 may then create and save an entity ID (act 408). In some embodiments, the entity ID may be a unique ID or key for identifying an entity.

Developer component 102 may then validate the entity (act 410). Developer component 102 may validate the entity by performing a Human Interactive Proof (HIP) check, such as, for example, presenting a string of characters in a manner which is difficult to recognize via optical character recognition and requesting the entity to enter the string of characters. Developer component 102 may further validate the entity by sending a confirmation e-mail, including a link, to the entity. After receiving the email, the entity may select the link, thereby confirming that the email is a valid email address. Of course, numerous other methods for validating the entity may be performed in other embodiments.

The entity may then be presented with terms of use, with which the entity may be requested to sign and accept (act 412). For example, the entity may be presented with terms of use, explaining terms for using the system, and may be requested to indicate acceptance of the terms of use by selecting an icon or a box, on a display screen, with a pointing device, such as, a computer mouse, a stylus, or other pointing device. Developer component 102 may then provide the entity with an entity ID. In some embodiments, the entity ID may be a unique ID or key.

After performing act 414, or after determining, during act 404, that the entity is already provisioned, developer component 102 may permit creation of an application (act 416). The application may be created by uploading a copy of the application to developer component 102, by the entity providing a link to a location storing a copy of the application, or by a number of other methods.

Developer component 102 may then obtain the application metadata, describing the application, from the entity, and may save the application metadata (act 418). The application metadata may be saved and provisioning data store 104, in some embodiments. The application metadata may describe various aspects of the application, such as, for example, a category of the application, a cost range of the application, a version of the application, a language of the application, as well as other aspects. The developer component 102 may then create an application provisioning record based, at least partly, on the provided application metadata (act 420).

Developer component 102 may then establish application tracking based, at least partly, on the provided application metadata and/or other information (act 422). Application tracking data store 106 may then be responsible for receiving tracked data based on execution of the application.

Developer component 102 may then register the application in an application directory (act 424). The registered application may be in a state in the application directory, such that, only the entity and affiliated parties may view, or discover, a registration entry for the application in the application directory.

Developer component 102 may then return application configuration information to the entity (act 426). The application configuration information may include a unique ID or key for identifying the application.

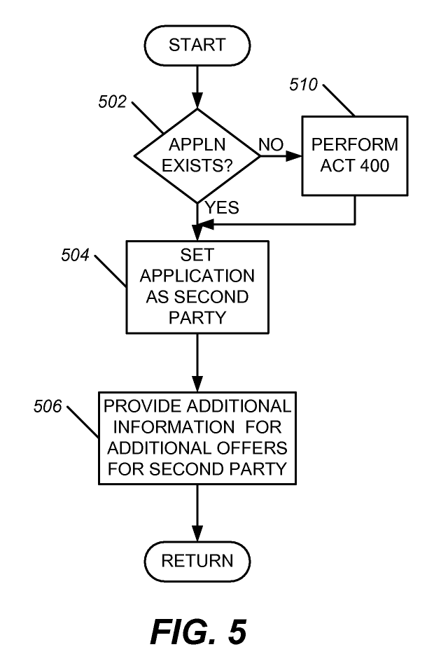

FIG. 5 is a flowchart illustrating an exemplary process for provisioning a second party in embodiments consistent with the subject matter of this disclosure. Second party provisioning may occur in a number of different ways. For example, an entity, such as a developer or other entity, may go through an application provisioning process, such as the process described in FIG. 4, or another process, as a third party, to provision an application. When provisioning the application as a second party, the application may be promoted to be a second party through use of an administrative tool to which system administrators may have access. Another method for performing second party provisioning may include a system administrator creating an application on behalf of an entity, and enabling the application to be a second party.

The exemplary process may begin by determining whether an application exists and is already provisioned (act 502). If the application is already determined to exist and be provisioned, then the system may set the application to be a second party (act 504). A second party may be a party with a specific type of relationship with those responsible for the system. For example, the second party may be a business partner of those responsible for the system.

The system may then provide information for additional offers for the second party (act 506). For example, information regarding specific APIs, or applications, may be available to second parties, but not available to non-second party users. The information may be published to an application metadata store for use by the second parties.

If, during act 502, the system determines that the application is not provisioned, then the system may perform act 400 of FIG. 4 (act 510) to provision the application. Acts 504-506 may then be performed, as previously described.

A first party may be a party who developed or who owns an online application platform. Examples of second parties may include applications for use by a particular product of the first party, such as, for example, applications for use by a handheld multimedia player, a video gaming system, or other first party products.

In some embodiments, the exemplary process of FIG. 5 may be executed by developer component 102. In other embodiments, other components of the system may execute the exemplary process of FIG. 5.

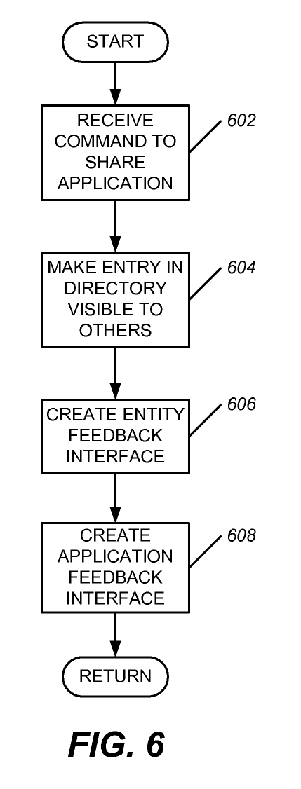

FIG. 6 is a flowchart illustrating an exemplary process, which may be performed in embodiments consistent with the subject matter of this disclosure, after a command is received to share an existing provisioned application. The process may begin with developer component 102, or another component of the system, receiving a command to share an application (act 602). Developer component 102 may then make an entry in an application directory, such that the entry may be visible only to certain users, such as, for example, a third party, a second party, or users affiliated with the third party or the second party (act 604). The system may then create an entity feedback interface (act 606) and an application feedback interface (act 608). In some embodiments, the entity feedback interface may be a developer home page and the application feedback interface may be an application home page, both of which may be accessible to the third party (or second party), as well as users of a user community.

### Miscellaneous

When applications are uploaded to the system, users of the user community may execute the applications on the system and the system may track execution of the application and store related data in an application tracking data store, such that business intelligence may be created from the stored data.

In some cases, applications may be executed on processing devices outside of the system. For example, a user may execute an application on a processing device outside of the system. The application may use services of the system by making calls to one or more APIs of the system. As mentioned previously, if the application is set as a second party, the application may be provided with additional offerings by the system.

### CONCLUSION

Although the subject matter has been described in language specific to structural features and/or methodological acts, it is to be understood that the subject matter in the appended claims is not necessarily limited to the specific features or acts described above. Rather, the specific features and acts described above are disclosed as example forms for implementing the claims.

Although the above descriptions may contain specific details, they are not to be construed as limiting the claims in any way. Other configurations of the described embodiments are part of the scope of this disclosure. Further, implementations consistent with the subject matter of this disclosure may have more or fewer acts than as described, or may implement acts in a different order than as shown. Accordingly, the appended claims and their legal equivalents define the scope of the invention, rather than any specific examples given.

We claim as our invention:

1. A machine-implemented method for provisioning an application, the machine-implemented method comprising:
determining whether an entity associated with the application is provisioned;
provisioning the entity when the entity is determined to not be provisioned;
creating the application;
obtaining and saving application metadata;
creating an application provisioning record based, at least partly, on the saved application metadata;
establishing tracking for the application to produce tracking data for business intelligence; and
registering the application in a searchable directory.

2. The machine-implemented method of claim 1, wherein:
the registering of the application in the searchable directory comprises:
creating an entry in the searchable directory, the entry being non-visible to users unaffiliated with the entity.

3. The machine-implemented method of claim 2, further comprising:
making the entry in the searchable directory visible to users unaffiliated with the entity upon receiving a command to share the application.

4. The machine-implemented method of claim 1, further comprising:
creating an interface for a user community to provide feedback with respect to the entity; and
creating an interface for the user community to provide feedback with respect to the application.

5. The machine-implemented method of claim 4, wherein the creating of the application further comprises:
performing either uploading of the application to a server, or providing a link to an external resource including the application.

6. The machine-implemented method of claim 1, further comprising:
provisioning the application as a second party user, the provisioning including additional offerings not available to non-second party users.

7. The machine-implemented method of claim 6, wherein the additional offerings comprise at least one application program interface or at least one service not provided to the non-second party users.

8. A system for provisioning an application, the system comprising:
a developer component comprising:
at least one processor, and
a memory connected to the at least one processor, the memory comprising:
instructions for receiving a request to provision resources for the application associated with an entity,
instructions for provisioning resources for the entity when the entity has no resources provisioned,
instructions for creating the application,
instructions for obtaining and saving application metadata,
instructions for allocating a resource to track application usage and to produce application usage data accessible by the entity, and
instructions for non-publically registering the application in a searchable directory.

9. The system of claim 8, further comprising:
an application tracking data store component for storing application usage data, application business intelligence to be produced from the stored application usage data.

10. The system of claim 8, further comprising:
a provisioning data store for storing application data including the application metadata;
an application feedback component for creating an application home page including application information, the application home page further provides a facility for users of a user community to provide feedback with respect to the application; and
an entity feedback component for creating an entity home page including entity information, the entity home page further provides a facility for the users of the user community to provide feedback with respect to the entity.

11. The system of claim 8, wherein the instructions for creating the application comprise:
instructions for receiving and storing an uploaded application, and
instructions for receiving a link to an external resource including the application.

12. The system of claim 8, wherein the memory further comprises:
instructions for provisioning a second application as a second party user, the instructions for provisioning a second application as a second party user further comprise instructions for providing offerings to the second party user, the offerings being unavailable for non-second party users.

13. The system of claim 8, further comprising:
a subscription component for providing a facility for users to become subscribers to an information update service with respect to one or more applications, the subscription component being further for dynamically communicating updates to the subscribers.

14. The system of claim 8, further comprising:
an application directory component for creating a searchable application directory based on application information including the application metadata, the application directory being accessible to users of a user community.

15. The system of claim 14, wherein the application directory component categorizes the application based on the application metadata.

16. A provisioning system to enable online application tools and user communities, the system comprising:
a developer component for providing a facility for a developer to request a provision of resources for an application, for the developer to enter application metadata, and for provisioning the application;
a provisioning data store component for storing application data including the application metadata; and
an application tracking data store for storing data pertaining to use of the application by users of a user community.

17. The system of claim 16, wherein the developer component is further for producing application business intelligence for the developer based on the data pertaining to use of the application by the users of the user community.

18. The system of claim 16, wherein the developer component is further for creating an application home page, accessible to the users of the user community, to provide information to the users of the user community about the application and to receive feedback from the users of the user community with respect to the application.

19. The system of claim 16, wherein the developer component is further for creating a developer home page, accessible to the users of the user community, to provide information to the users of the user community about the developer and to receive feedback from the users of the user community with respect to the developer.

20. The system of claim 16, wherein the developer component is further for creating a searchable entry, with respect to the application, in an application directory accessible to the users of the user community, the searchable entry having tags based, at least partly, on the entered application metadata.
